(19) United States
(12) Patent Application Publication
(10) Pub. No.: US 2014/0108105 A1
(43) Pub. Date: Apr. 17, 2014

(54) Agent Relationship Portal

(71) Applicants: Jacob Walter Wagner, Carver, MN (US); Marco Prinetti, Roma (IT); Marsha June Hemric, Westminster, CO (US); William Gutierrez, JR., Cedar Park, TX (US); Dean Evan Cole, Oakdale, MN (US); Todd William McMullen, Morrison, CO (US)

(72) Inventors: Jacob Walter Wagner, Carver, MN (US); Marco Prinetti, Roma (IT); Marsha June Hemric, Westminster, CO (US); William Gutierrez, JR., Cedar Park, TX (US); Dean Evan Cole, Oakdale, MN (US); Todd William McMullen, Morrison, CO (US)

(73) Assignee: Moneygram International, Inc., Minneapolis, MN (US)

(21) Appl. No.: 13/654,192

(22) Filed: Oct. 17, 2012

(51) Int. Cl. G06Q 10/06

(52) U.S. Cl. CPC G06Q 10/06398
USPC 705/7.42

(57) ABSTRACT

Systems and methods which assist a parent entity in directing an agent entity toward a desired course of action are provided. Embodiments may include one or more data processing devices which compile data for the parent entity regarding the agent entity. Such data may include any number of metrics relating to the actions of an agent entity such as types of transactions processed by the agent, information corresponding to the specific details of the transactions, information pertaining to the agent entity itself (such as location information, transaction volume information and the like), data corresponding to the employee facilitating the transactions, etc. The compiled data may be used by the parent entity to create an incentive program in order to incentivize an agent entity to modify behaviors or to reward observed behaviors.

### TECHNICAL FIELD

The present application relates to systems and methods for assisting a parent entity in directing an agent entity toward a desired course of action.

### BACKGROUND

Throughout the course of operation of a business entity, such as a retail establishment or service industry, a primary concern for the functioning of the business is how to properly incentivize employees/contractors to take steps for performing their job in accordance with what may provide a desired or more efficient outcome. Because of this, a large expenditure for any business may come in the form of training or other programs to direct such employees or contractors to act in a particular manner.

The ability to direct operations becomes even more complicated in circumstances where a parent business does not have complete control over an agent business or franchisee that maintain a certain degree of autonomy with respect to the parent business. In such circumstances where a parent business would like to direct a franchisee or agent to take particular steps, or train an individual employee of an agent with certain skills, the interests of the franchisee or agent business may not align with the parent business (e.g. where there is no motivation to take a particular course of action, training takes too much paid employee time, etc.).

For example, in the field of a money transfer service industry, often the individual storefront locations, where money transfer transactions are originated and completed, are independently owned by an agent entity. Such an agent entity may find that particular forms of transactions tend to be more efficient on their time despite other forms of transactions having other benefits to the parent money transfer company. Moreover, certain products that are available from the parent company may not be utilized by an agent if the agent does not perceive any appreciable benefit to take the time and learn about a new product or attempt to utilize the product.

Additionally, specific training for agent employees that may yield efficiency within the transaction processing methods of the parent company may not be desirable to implement from the agent's perspective due to the time/expense of the employee undertaking the training. However, such training may be very important to the parent company, such as in circumstances where anti-fraud or other loss prevention methods could be better implemented.

### BRIEF SUMMARY

The present application provides for systems and methods which assist a parent entity in directing an agent entity toward a desired course of action. Embodiments may include one or more data processing devices which compile data for the parent entity regarding the agent entity. Such data may include any number of metrics relating to the actions of an agent entity such as types of transactions processed by the agent, information corresponding to the specific details of the transactions, information pertaining to the agent entity itself (such as location information, transaction volume information and the like), data corresponding to the employee facilitating the transactions, etc. The compiled data may be used by the parent entity to create an incentive program in order to incentivize an agent entity to modify behaviors or to reward observed behaviors.

Embodiments may also utilize compiled data specific to an employee of the agent entity in a manner to direct behavior of the employee. For example, compiled data may include information regarding the amount of training and/or experience of an employee in certain areas. This data may be utilized to establish or implement a reward or incentive program for the employee to attempt further training, additional types of transactions, etc.

In accordance with a specific embodiment, a method is provided which includes the steps of compiling data at a server administered by a parent money transfer service entity where the data includes data relating to an agent money transfer service entity. The method further includes establishing an incentive program using the compiled data. The incentive program may be configured to incentivize and reward one or more behaviors which have been pre-determined by the parent entity. Moreover, the method includes monitoring, by a processing device administered by the parent money transfer service entity, data relating to actions taken by the agent money transfer service entity in order to determine whether milestones of the incentive program have been achieved.

Yet another embodiment provides for a system comprising a central processing unit belonging to a parent money transfer service entity. The central processing unit is configured to receive data from a plurality of remote processing units belonging to agent money transfer service entities. This data is then processed and stored at a central storage server. The central processing unit may be further configured to compile the received data and to administer a generated incentivization program specific to one or more agent entities. This program is configured to incentivize the agent entities to undertake particular actions, as determined by the parent entity. The central processing unit may be further configured to monitor data relating to actions taken by the agent money transfer service entity in order to determine whether milestones of the incentivization program have been achieved.

Another embodiment may be described as a computing device having a computer-readable medium with code stored thereon, which when executed by a processing device, causes the computing device to compile data for storage at a parent money transfer service entity. This data may include data many forms of data relating to an agent money transfer service entity. With the compiled data, the computing device may establish an incentive program where the incentive program is configured to incentivize and reward one or more pre-determined (by the parent entity) behaviors taken by the agent entity. Additionally, the computing device may monitor data relating to actions taken by the agent money transfer service entity in order to determine whether milestones of said incentive program have been achieved. In the event that one or more milestones have been achieved, the computing device may facilitate the payment of rewards in accordance with the incentive program guidelines.

The foregoing has outlined rather broadly the features and technical advantages of the present invention in order that the detailed description that follows may be better understood. Additional features and advantages will be described hereinafter which form the subject of the claims. It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of embodiments described herein, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present embodiments.

### BRIEF DESCRIPTION OF THE DRAWINGS

For a more complete understanding, reference is now made to the following descriptions taken in conjunction with the accompanying drawings, in which:

FIG. 1 illustrates a system for facilitating one or more money transfer transactions in accordance with an embodiment of the present application;

FIG. 2 illustrates a flowchart of a method for facilitating an incentive program in accordance with an embodiment of the present application;

FIG. 3 illustrates a flowchart of a method for facilitating an incentive program in accordance with an embodiment of the present application; and

FIG. 4 illustrates an exemplary computer system which may be employed to implement the above-described servers/processing devices, agent devices (such as POS devices) or user devices according to certain embodiments.

### DETAILED DESCRIPTION

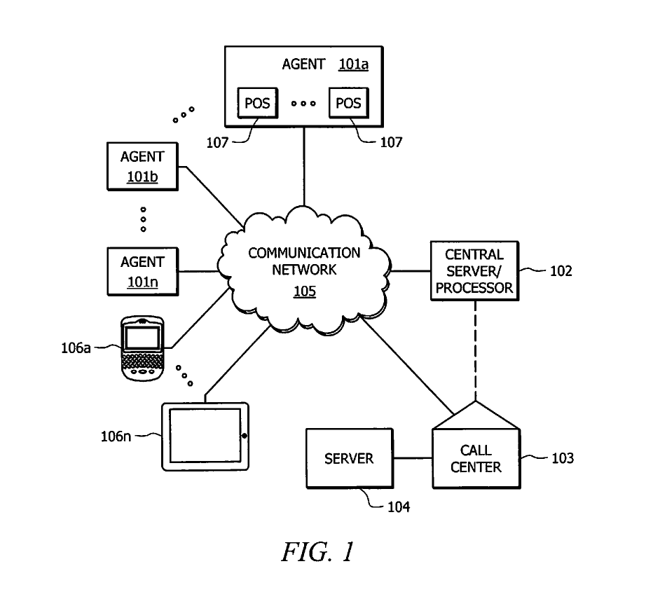

FIG. 1 illustrates a system 100 for facilitating one or more money transfer transactions in accordance with an embodiment of the present application. System 100 includes agent devices 101a-101n, central server/processing device 102, call center 103 having an optional server 104, and user devices 105a-105n. It is noted that much of the discussion herein is provided in the context of a money transfer service business. However, it is appreciated that one of ordinary skill in the art would understand that the described systems, methods, and techniques may be implemented in other contexts which have similar structural concerns within the respective business (e.g. where a parent entity and an agent entity exist and a parent entity wants to direct an agent entity's actions).

Communications between devices in system 100 may be facilitated in whole, or in part, by communication network 105. Communication network 105 may comprise the Internet, WiFi, mobile communications networks such as GSM, CDMA, 3G/4G, WiMax, LTE, and the like. Further, communications network 105 may comprise a combination of network types working collectively.

Agent devices 101a-101n may correspond to computer systems within a money transfer agent location. Agent devices 101a-101n could include special purpose computers programmed to implement steps described herein, or could be conventional processing devices configured to run software which facilitates the described money transfer transactions. For example, such devices may be computer systems which are accessible by an agent at an agent location, may be automated machines such as an Automated Teller Machine (ATM), and the like. Agent devices 101a-101n may be located throughout the world and one or more devices may be utilized within a single money transfer transaction. Agent devices 101a-101n are configured to send and receive information over communication network 105. In some embodiments, agent devices 101a-101n may also have a direct connection with central server/processing device 102. Agent devices 101a-101n may be configured to transmit transaction information or any other information pertaining to the agent between respective devices of system 100, such as to central server/processing device 102.

Central server/processing device 102 is configured to facilitate an incentive or reward program in accordance with pre-determined criteria outlined by a parent money transfer service entity. As described above, a parent money transfer service entity may desire to direct, or incentivize, one or more agents to take particular actions within the agent business, facilitate certain types of transactions, and the like. Central server/processing device 102 is configured to compile information relating to one or more agent locations 101a-101n. In some embodiments, central server/processing device 102 may also act as a processing device which facilitates the overall money transfer transactions. Alternatively, embodiments may include a separate central server/processing device to facilitate money transfer transactions and an incentive program, respectively.

Information compiled by central server/processing device 102 may include any type of information which may be helpful to facilitate an incentive program which will help a parent entity direct actions within an agent entity. For example, information relating to the type, frequency, destinations, etc., of transactions initiated or finalized by an agent entity may be utilized in order to monitor the transactions and direct or improve the agent entity's actions via an incentive program. An example of improving an agent entity's actions may include encouraging the agent entity to create a different style of transaction, obtain more information regarding the transaction (such as additional security information relating to a sender or receiving party), and the like.

Information compiled by central server/processing device 102 may also include location-specific information regarding an agent entity. As can be appreciated, such information may be utilized in numerous ways. For example, an incentive program which may be useful for one location, e.g. within the United States, may not be ideal for an agent entity in a different location, such as within African countries. Accordingly, information relating to an agent entity's location may be utilized both in determining possible actions used by the parent company to direct an agent entity. Further, location information may be utilized to determine the types of incentives actually rewarded to an agent entity, as it is appreciated that differing rewards will be appreciated differently among locations.

In some embodiments, central server/processing device 102 may also compile more specific information relating to an agent entity. For example, an incentive program may be generated based on the actions of a specific employee of the agent entity. Such information may be useful to a parent entity which desires that an employee of an agent entity obtain specific training. By way of example, in a money transfer service context it is important that an employee of an agent understands techniques and policies which are implemented to prevent fraud, money laundering, and the like. Additionally, for the sake of efficiency, it is useful for an agent employee to fully understand how to create a money transfer transaction so as to avoid frequent use of technical support or other services provided by a parent entity such as at call center 103.

Central server/processing device 102 may also be configured to monitor the progress of an incentive program and to facilitate payment incentives to an agent money transfer service entity in accordance with an established incentive program. Incentives may be implemented in any form which would be useful to incentivize an individual or agent entity such as a cash reward, non-tangible value unit, recognition awards, and the like. Non-tangible value units may comprise any unit such as points from a reward point system or other measure which may be translated to value such as fake gems, fake money, coupons, etc., and such rewards may be determined based on any number of factors. For example, the value of an action taken (or milestone achieved within the incentive program) by an agent entity may increase or decrease the value of a reward. Additionally, incentives may be determined based on the location of the agent money transfer service entity. For example, rewards may include special coupons or giveaways corresponding to a retail establishment which is proximate to the agent.

Call center 103 may be administered by the parent entity. However, in some embodiments it may be administered by an entity other than both the parent and the agent entity. Call center 103 may provide customer service for an agent entity attempting to establish a transaction. For example, in the event that an agent, such as agent 101a, needs assistance in creating or completing a transaction, call center 103 may be utilized by the agent in order to accomplish their goals. In this manner, call center 103 may be useful in compiling information relating to an agent entity or respective transactions, as call center 103 may be in a good position to observe where mistakes are occurring or difficulties arise. Call center 103 may include a server 104 to compile and store such data. Alternatively, call center 103 may be indirectly or directly connected to central server/processor 102 in order to provide relevant information to central server/processor 102.

User devices 106a-106n may be any type of device which would facilitate the exchange of information within system 100. For example, user devices may include computer systems, tablet devices, mobile telephones, and the like. Different embodiments may utilize different aspects of the types of client devices. For example, mobile telephones and tablet devices may have the ability to connect with various communications networks and may have different application execution capabilities. User devices 106a-106n may be utilized before, during and after a money transfer transaction in any manner to facilitate convenient and secure transactions.

For example, a user device 106 may be utilized to initiate a transaction and to begin the process of compiling information for the transaction corresponding to a sending party, receiving party, etc. The initial information may be sent to an agent location to facilitate an expedient transaction. Further, in some embodiments, applications executed on user devices 106a-106n may initiate the described money transactions and send the funds via the agent location. In such embodiments, the transaction may be facilitated entirely online through a portal or online application corresponding to the agent location. Alternatively, embodiments may compile the transaction information whereupon the sending party may complete the sending portion of the transaction (e.g. provide funds for the transaction) at the agent location.

Further, a user device 106 may be utilized to provide transaction information to a sender or receiver. For example, once a money transfer transaction is initiated, a transaction code may be sent to the sender or receiving party. In the event that the transaction code is sent to the sender, the sender may convey that code to the receiver. Such a transaction code may be utilized by the receiving party to initiate the receipt of the money transfer transaction in order to complete the transaction. For example, a received transaction code may be provided to an agent 101a-101n, either electronically or in person, by a receiving party to finalize a money transfer transaction.

In some embodiments, it is noted that an agent, such as agent 101a, may include multiple point of sale (POS) devices 107 in a single location, distributed among multiple locations (in some cases in communication over communication network 105), or combination of both. In instances where multiple POS devices 107 are located within a single agent location, embodiments may direct communications involving an incentive program or cause additional training or other information to be directed to one of the devices in order to avoid over utilizing the resources of an agent entity. For example, employee training may be facilitated on a POS device in communication with central server/processor 102, however such training should not interfere with regular transaction processing at an agent location.

Embodiments where multiple POS devices 107 are distributed among multiple locations may occur in situations, for example, where the agent is part of a chain of retail locations. In such instances, an incentive program may be administered with respect to information derived on or between the multiple POS devices 107. For example, an incentive program may generate a competition between locations within a retail chain and may reward a particular location based on observed activity. Additionally, an incentive program may create a reward schema arising from competition between agent locations such as agent 101a and agent 101b.

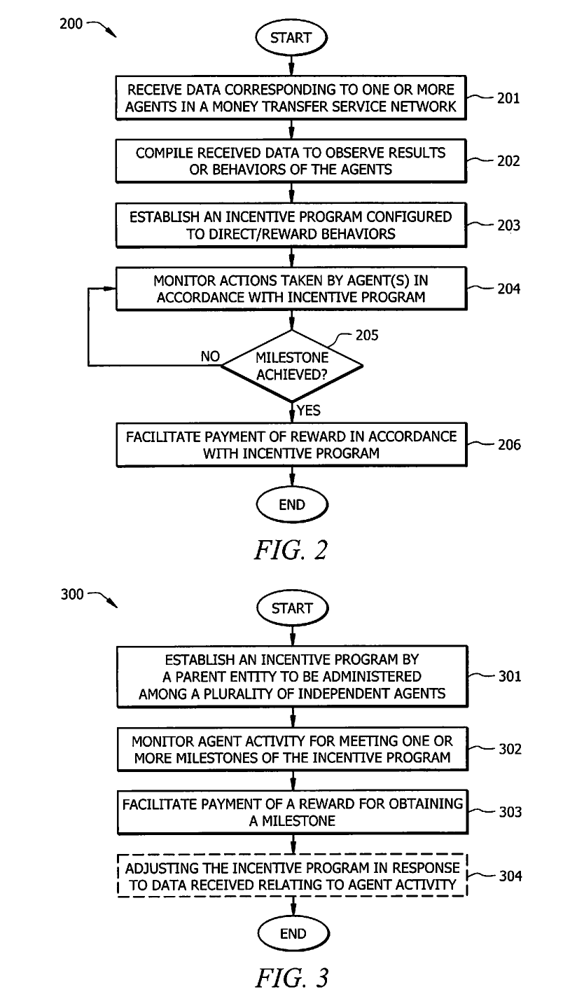

FIG. 2 illustrates a flowchart of a method 200 for facilitating an incentive program in accordance with an embodiment of the present application. Method 200 may be implemented within a system such as system 100 or any other suitable system. Additionally, while method 200 is set forth in steps, it is noted that nothing in this application necessarily limits the order in which the illustrated steps are implemented. In fact, some steps may be implemented in different orders, simultaneously, at multiple points in time, or not at all.

Method 200 begins by receiving data corresponding to one or more agents in a money transfer service network 201. As described above, such data may include information relating to transactions processed by the agent, information relating to the location of the agent, information relating to a specific employee of an agent, etc.

The received data is then compiled (generally by a processing device administered by a parent entity) in order to observe results or behaviors of the agents at step 202. Such observations may include alterations relating to the type, volume, or frequency of transactions, training information relating to an employee of an agent, or any other observations which may be derived from the received data.

With the compiled data, in incentive program may be established at block 203, which is configured to direct/reward behaviors of the one or more agents. It is appreciated that the type of incentive program established, and the reward given, may be highly dependent on the particular application or embodiment being implemented. For example, an incentive program may be simple and provide recognition to an agent for meeting a specific milestone, such as for establishing a certain number of transactions, or a certain dollar amount of volume. Alternatively, incentive programs may be more complicated. For example, a program may provide for a predetermined amount of points or other intangible units of value for the accomplishment of various milestones such as for creating a specific type of transaction, completing a certain level of training, signing up a customer into a loyalty program, etc. Such units of value may be redeemed for other prizes such as cash rewards, gift cards, and the like. Moreover, rewards may be provided which provide for advantages within the overall parent network. For example when certain levels of milestones have been achieved, a particular agent may receive a preferential status within the money transfer network. Such a preferential status may include providing a preferential or faster support when utilizing call center 103, etc.

With the incentive program established, method 200 monitors actions taken by one or more agents in accordance with the established incentive program at block 204. Such monitoring may be implemented by a processing device (such as central server/processor 102) administered by a parent entity. Alternatively, monitoring may be implemented by a combination of devices distributed between a parent entity and an agent. Further, monitoring may be implemented in real-time, at specific polling times, or in accordance with any other preference which facilitates efficient communication and functioning of the underlying industry. Embodiments are not generally limited by the type and manner of monitoring which is implemented for a particular incentive program.

At block 205 is a milestone is achieved in accordance with the established incentive program, method 200 continues to block 206 where payment of the award in accordance with the incentive program is facilitated. In the event that a milestone is not achieved, method 200 continues at block 204 with monitoring actions taken by the one or more agents.

It is appreciated that the facilitation of a payment of an award may be implemented in a number of manners. For example, a processing device administered by a parent entity may maintain a user account for an agent (or an employee of an agent) which tracks particular rewards earned and allows for reward redemption to be facilitated via the established account. In other embodiments, payment of rewards may be in the form of recognition messages or tokens which are sent upon confirmation that a particular milestone was achieved. Further, in some embodiments, upon recognizing that a milestone has been achieved, a processing system within the parent entity may facilitate the mailing of a predetermined gift, gift card, and the like.

FIG. 3 illustrates a flowchart of a method 300 for facilitating an incentive program in accordance with an embodiment of the present application. Method 300 may also be implemented within a system such as system 100 or any other suitable system. Additionally, while method 300 is set forth in steps, it is noted that nothing in this application necessarily limits the order in which the illustrated steps are implemented. In fact, some steps may be implemented in different orders, simultaneously, at multiple points in time, or not at all.

Method 300 begins by establishing an incentive program by a parent entity which is to be administered among a plurality of independent agents 301. This incentive program may be specifically tailored to individual agents or may be applicable to a plurality of agents. With the incentive program established, method 300 monitors agent activity for an indication that one or more milestones of the incentive program have been met at block 302. Once a milestone has been met, at block 303, payment of a reward for obtaining the milestone is facilitated.

It is appreciated that method 300 may utilize the techniques for establishing, monitoring and facilitating payment relating to an incentive program as described above with respect to other embodiments. Further, method 300 may include the optional step of the adjusting the incentive program in response to data received relating to activity of one or more agents. For example, if a particular milestone becomes either too easy or too difficult to achieve, the milestone may be adjusted. Additionally, milestones which are created may be awarded for only a limited number of occurrences (e.g. a reward for a particular type of transaction to be established among the agents until a particular number of transactions have been achieved among the agents), and once that number of occurrences are met, the incentive program may be adjusted. Many types of adjustments may be implemented in accordance to the particular incentive program which is then established.

The following description provides example implementations of an incentive program. These examples are provided so as to illustrate the possible uses of the concepts described in the present application. As such, the following examples should not be construed as limiting on the claims unless specifically acknowledged in the claim language.

### EXAMPLES

One example implementation may provide for an incentive schema to encourage training for individual employees of an agent money transfer service provider. A parent money transfer service entity may have a multitude of training modules which may include relevant information for an individual who acts on behalf of an entity to establish a money transfer transaction. The type of modules which should be utilized or viewed may vary depending on: the location of the agent, the types of transactions consistently undertaken, particularly relevant or important fraud procedures, etc. Further, the types of modules that should be utilized may also vary based on the specific employee and that employee's underlying experience.

To use fraudulent transaction training as an example, an agent employee may be confronted with various situations where the employee must look out for the potential of fraud. For example, if an elderly customer enters a money transfer service location and is requesting to send funds as part of what is then recognized as a common e-mail scam, it is important for an agent to recognize the potential for fraud. Because of this, a training incentive program may be established which incentivizes an employee to undertake relevant fraudulent transaction recognition training. As result of taking such training, the employee may be rewarded with points, promotions, gift cards, and the like.

In one example, an incentive program may be implemented which provides for levels of training, whereupon an employee attempts to obtain one or more levels of knowledge. Upon achieving a level, the incentive program may provide differing rewards. Levels of training may be segregated by beginning, intermediate, and advanced levels, or by any other schema such as by category (e.g. a category for types of transactions, a category for security/loss prevention training, categories relating to additional product sales such as customer loyalty programs, bill payment programs, etc.). As a result, an individual employee is incentivized to undertake training and is rewarded for their time and effort.

In some instances, the incentive program may also provide rewards for the independent agent for having a number of employees which have exceeded certain training levels. In this manner, the agent employer is also incentivized to allow its employees to obtain more training.

A result of such training is that it may provide appreciable benefits to the parent transfer service entity at least because precautions are taken which minimize the amount of errors in transactions, minimize the amount of resources which must be devoted to a call center, and the like. Further, embodiments may allow the parent entity to have resources to monitor and process the data flow and statistics relating to transactions and agent activity in order to establish helpful incentive programs. This monitoring may notify the parent entity when a particular amount of training may be needed based on mistakes or other observed occurrences.

Another example implementation may be in the form of a reward schema for an agent (or owner of an agent location). In this example, the parent entity may collect and monitor information regarding the actions of an agent and utilize this information to provide incentives for future actions. For example, milestones may be defined based on the amount of money or volume transferred, the amount of countries where money transfers have been sent from the agent location, the amount of miles traversed by the respective money transfer transactions, the training levels obtained by employees, etc. These milestones may then be celebrated in various manners. Such a celebration may be simple, for example, the parent entity may indicate to an agent entity the amount of miles traversed with their transactions (e.g. three times around the globe, and the like), and could provide a small token or badge to commemorate the accomplishment. Another example may be an indication that a particular agent is outperforming other agents in the region. Such a notification could help facilitate an environment of competition, and therefore increase sales. Additionally, an incentive program may act to foster this competition and drive a particular direction of sales.

Additionally, such information may be helpful to respective agents in order for them to have increased information regarding the performance of their respective locations, employees, etc. The parent entity may also use this information to identify under-performing or over-performing agent locations.

As can be appreciated by the above description, embodiments, or portions thereof, may be embodied in program or code segments operable upon a processor-based system (e.g., computer system or computing platform) for performing functions and operations as described herein. The program or code segments making up the various embodiments may be stored in a computer-readable medium, which may comprise any suitable medium for temporarily or permanently storing such code. Examples of the computer-readable medium include such tangible computer-readable media as an electronic memory circuit, a semiconductor memory device, random access memory (RAM), read only memory (ROM), erasable ROM (EROM), flash memory, a magnetic storage device (e.g., floppy diskette), optical storage device (e.g., compact disk (CD), digital versatile disk (DVD), etc.), a hard disk, and the like.

Embodiments, or portions thereof, may be embodied in a computer data signal, which may be in any suitable form for communication over a transmission medium such that it is readable for execution by a functional device (e.g., processor) for performing the operations described herein. The computer data signal may include any binary digital electronic signal that can propagate over a transmission medium such as electronic network channels, optical fibers, air, electromagnetic media, radio frequency (RF) links, and the like, and thus the data signal may be in the form of an electrical signal, optical signal, radio frequency or other wireless communication signal, etc. The code segments may, in certain embodiments, be downloaded via computer networks such as the Internet, an intranet, a local area network (LAN), a metropolitan area network (MAN), a wide area network (WAN), the public switched telephone network (PSTN), a satellite communication system, a cable transmission system, and/or the like.

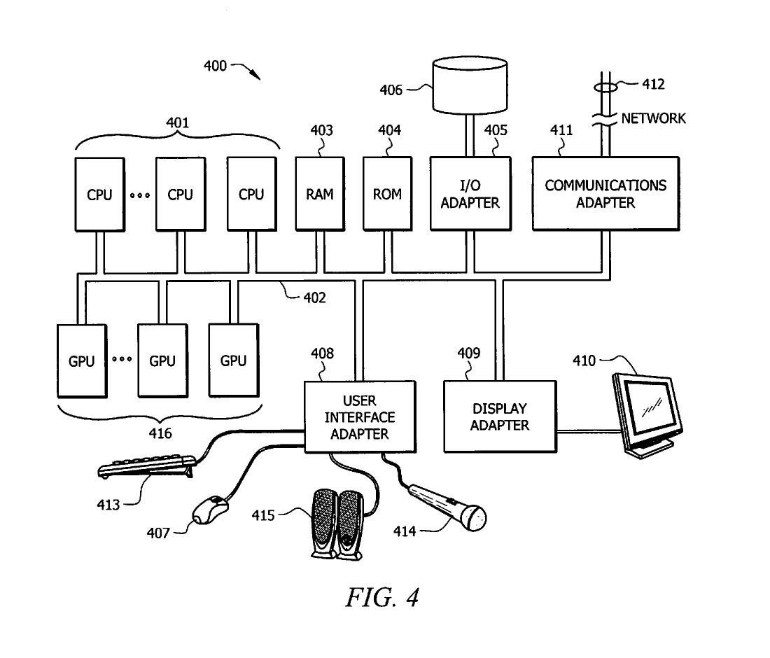

FIG. 4 illustrates an exemplary computer system 400 which may be employed to implement the above-described servers/processing devices, agent devices (such as POS devices) or user devices according to certain embodiments. Central processing unit (“CPU” or “processor”) 401 is coupled to system bus 402. CPU 401 may be any general-purpose processor. The present disclosure is not restricted by the architecture of CPU 401 (or other components of exemplary system 400) as long as CPU 401 (and other components of system 400) supports the inventive operations as described herein. As such, CPU 401 may provide processing to system 400 through one or more processors or processor cores. CPU 401 may execute the various logical instructions described herein. For example, CPU 401 may execute machine-level instructions according to the exemplary operational flow described above in conjunction with FIGS. 2-3. When executing instructions representative of the operational steps illustrated in FIGS. 2-3, CPU 401 becomes a special-purpose processor of a special purpose computing platform configured specifically to operate according to the various embodiments of the teachings described herein.

Computer system 400 also includes random access memory (RAM) 403, which may be SRAM, DRAM, SDRAM, or the like. Computer system 400 includes read-only memory (ROM) 404 which may be PROM, EPROM, EEPROM, or the like. RAM 403 and ROM 404 hold user and system data and programs, as is well known in the art.

Computer system 400 also includes input/output (I/O) adapter 405, communications adapter 411, user interface adapter 408, and display adapter 409. I/O adapter 405, user interface adapter 408, and/or communications adapter 411 may, in certain embodiments, enable a user to interact with computer system 400 in order to input information.

I/O adapter 405 connects to storage device(s) 406, such as one or more of hard drive, compact disc (CD) drive, floppy disk drive, tape drive, etc., to computer system 400. The storage devices are utilized in addition to RAM 403 for the memory requirements associated with performing the operations described herein. Communications adapter 411 is adapted to couple computer system 400 to network 412 (e.g. communications network 105 of FIG. 1), which may enable information to be input to and/or output from system 400 via such network 412 (e.g., the Internet or other wide-area network, a local-area network, a public or private switched telephony network, a wireless network, any combination of the foregoing). User interface adapter 408 couples user input devices, such as keyboard 413, pointing device 407, microphone 414 and/or output devices, such as speaker(s) 415 to computer system 400. Display adapter 409 is driven by CPU 401 or by graphical processing unit (GPU) 416 to control the display on display device 410. GPU 416 may be any various number of processors dedicated to graphics processing and, as illustrated, may be made up of one or more individual graphical processors. GPU 416 processes the graphical instructions and transmits those instructions to display adapter 409. Display adapter 409 further transmits those instructions for transforming or manipulating the state of the various numbers of pixels used by display device 410 to visually present the desired information to a user. Such instructions include instructions for changing state from on to off, setting a particular color, intensity, duration, or the like. Each such instruction makes up the rendering instructions that control how and what is displayed on display device 410.

It shall be appreciated that the present disclosure is not limited to the architecture of system 400. For example, any suitable processor-based device may be utilized for implementing the above-described incentive programs, including without limitation personal computers, laptop computers, computer workstations, multi-processor servers, and even mobile telephones. Moreover, certain embodiments may be implemented on application specific integrated circuits (ASICs) or very large scale integrated (VLSI) circuits. In fact, persons of ordinary skill in the art may utilize any number of suitable structures capable of executing logical operations according to the embodiments.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method comprising:
compiling data at a server administered by a parent money transfer service entity, said data including data relating to an agent money transfer service entity;
establishing an incentive program using said compiled data, said incentive program configured to incentivize and reward one or more agent entity behaviors which have been pre-determined by the parent entity; and
monitoring, by a processing device administered by said parent money transfer service entity, data relating to actions taken by the agent money transfer service entity in order to determine whether milestones of said incentive program have been achieved.

2. The method of claim 1 wherein said compiled data includes data relating to transactions processed by said agent money transfer service entity.

3. The method of claim 2 wherein said data relating to transactions includes at least one of the transaction amounts, transaction origination data, transaction destination data, and customer information.

4. The method of claim 1 wherein said compiled data includes data relating to the agent money transfer service entity.

5. The method of claim 4 wherein said data relating to the agent money transfer service entity includes information relating to the location of the agent money transfer service.

6. The method of claim 4 wherein said data relating to the agent money transfer service entity includes information relating to volume and types of transactions processed by the agent money transfer service.

7. The method of claim 1 wherein said incentive program incentivizes the agent to generate a specific type of transaction based on one or more of data relating to transactions processed by said agent money transfer service entity and data relating to the money transfer service entity.

8. The method of claim 1 wherein said compiled data includes data relating to a specific employee of an agent money transfer service entity.

9. The method of claim 8 wherein said data relating to a specific employee includes information regarding the type and amount of training that said employee has received.

10. The method of claim 8 wherein said data relating to a specific employee includes information regarding transactions which have been processed by said employee.

11. The method of claim 8 wherein said incentive program incentivizes the specific employee to undertake a particular training which is determined based on the data compiled relating to the specific employee.

12. The method of claim 8 wherein said incentive program incentivizes the agent money transfer service entity to cause the employee to undertake a particular training which is determined based on the data compiled relating to the specific employee.

13. The method of claim 1 further comprising paying out incentives to the agent money transfer service entity in accordance with the established incentive program.

14. The method of claim 13 wherein paying out incentives includes one or more of paying cash rewards, providing non-tangible value units, and providing recognition.

15. The method of claim 13 wherein the type incentives paid out to the agent money transfer service entity is determined based on location of the agent money transfer service entity.

16. The method of claim 13 wherein the type incentives paid out to the agent money transfer service entity is determined based on a milestone of the incentive program which is achieved within the agent money transfer service entity.

17. A system comprising:
a central processing unit belonging to a parent money transfer service entity configured to receive data from a plurality of remote processing units belonging to agent money transfer service entities and to process said data and to store said processed data to a central storage server,
wherein said central processing unit is further configured to compile the received data and to administer a generated incentivization program specific to one or more agent entities which incentivizes the agent entities to undertake particular actions, as determined by the parent entity, and
wherein said central processing unit is further configured to monitor data relating to actions taken by the agent money transfer service entity in order to determine whether milestones of said incentivization program have been achieved.

18. The system of claim 17 wherein said central processing unit is further configured to notify a remote processing unit when a milestone of said incentivization program has been reached at a given agent money transfer service entity location.

19. The system of claim 17 wherein said central processing unit is further configured to administer delivery of at least one reward in accordance with said incentivization program.

20. The system of claim 19 wherein said at least one reward includes a non-tangible value unit.

21. The system of claim 20 wherein the non-tangible value unit is redeemable for an additional prize.

22. The system of claim 17 wherein said central processing unit is configured to compile data relating to at least one of the agent entity, an agent entity employee, and transaction information relating to transactions of which the agent entity participated in processing.

23. The system of claim 22 wherein said central processing unit is configured to incentivize the agent entity to facilitate a particular type of transaction in response to the compiled data.

24. The system of claim 22 wherein said central processing unit is configured to incentivize an employee of said agent entity to undertake a particular training course determined in response to the compiled data.

25. A computing device having a computer-readable medium with code stored thereon, which when executed by a processing device, causes the computing device to:
compile data for storage at a parent money transfer service entity, said data including data relating to an agent money transfer service entity;
establish an incentive program using said compiled data, said incentive program configured to incentivize and reward one or more pre-determined behaviors by the agent entity; and
monitor data relating to actions taken by the agent money transfer service entity in order to determine whether milestones of said incentive program have been achieved.

26. The computing device of claim 25 wherein said compiled data includes data relating to transactions processed by said agent money transfer service entity.

27. The computing device of claim 26 wherein said data relating to transactions includes at least one of the transaction amounts, transaction origination data, transaction destination data, and customer information.

28. The computing device of claim 25 wherein said compiled data includes data relating to the agent money transfer service entity.

29. The computing device of claim 28 wherein said data relating to the agent money transfer service entity includes information relating to the location of the agent money transfer service.

30. The computing device of claim 28 wherein said data relating to the agent money transfer service entity includes information relating to volume and types of transactions processed by the agent money transfer service.

31. The computing device of claim 25 wherein said incentive program incentivizes the agent to generate a specific type of transaction based on one or more of data relating to transactions processed by said agent money transfer service entity and data relating to the money transfer service entity.

32. The computing device of claim 25 wherein said compiled data includes data relating to a specific employee of an agent money transfer service entity.

33. The computing device of claim 32 wherein said data relating to a specific employee includes information regarding the type and amount of training that said employee has received.

34. The computing device of claim 32 wherein said data relating to a specific employee includes information regarding transactions which have been processed by said employee.

35. The computing device of claim 32 wherein said incentive program incentivizes the specific employee to undertake a particular training which is determined based on the data compiled relating to the specific employee.

36. The computing device of claim 32 wherein said incentive program incentivizes the agent money transfer service entity to cause the employee to undertake a particular training which is determined based on the data compiled relating to the specific employee.

37. The computing device of claim 25 further configured to pay out incentives to the agent money transfer service entity in accordance with the established incentive program.

38. The computing device of claim 37 wherein paying out incentives includes one or more of paying cash rewards, providing non-tangible value units, and providing recognition.

39. The computing device of claim 37 wherein the type incentives paid out to the agent money transfer service entity is determined based on location of the agent money transfer service entity.

40. The computing device of claim 37 wherein the type incentives paid out to the agent money transfer service entity is determined based on milestone of the incentive program which is achieved within the agent money transfer service entity.
